(19) United States
(12) Patent Application Publication
(10) Pub. No.: US 2025/0148829 A1
(43) Pub. Date: May 8, 2025

(54) ACTION RECOGNITION METHOD AND APPARATUS, AND ELECTRONIC DEVICE AND STORAGE MEDIUM

(71) Applicant: Beijing Zitiao Network Technology Co., Ltd., Beijing (CN)

(72) Inventor: Jie WU, Beijing (CN)

(21) Appl. No.: 18/836,736

(22) PCT Filed: Feb. 6, 2023
(86) PCT No.: PCT/CN2023/074537

§ 371 Date: Aug. 7, 2024

(30) Foreign Application Priority Data
Feb. 7, 2022 (CN) 202210116704.X

(51) Int. Cl. G06V 40/20; G06V 10/77; G06V 10/80; G06V 20/40

(52) U.S. Cl. CPC G06V 40/20; G06V 10/7715; G06V 10/811; G06V 20/49

(57) ABSTRACT

An action recognition method, an electronic device, and a non-transitory storage medium are provided. The action recognition method includes: augmenting an original video to obtain a plurality of augmented video segments; extracting multi-level video features of the plurality of augmented video segments based on a pre-trained action recognition model, and outputting an action recognition result of the original video according to the multi-level video features of the plurality of augmented video segments.

The present application claims priority of China Patent Application No. 202210116704.X on Feb. 7, 2022, the entirety of which is incorporated into the present application by reference.

### TECHNICAL FIELD

The present disclosure relates to the field of computer technologies, for example, relates to an action recognition method, device, electronic device and storage medium.

### BACKGROUND

Action recognition is a fundamental task in computer vision, which plays a pivotal role in video structure analysis and potential downstream applications. Due to the diversity of action categories, it is required to rely on sufficient video data of various actions to train an action recognition model, which is costly for screening and labelling video data.

### SUMMARY

The present disclosure provides an action recognition method and apparatus, an electronic device, and a storage medium, can complete model training based on a small amount of data while ensuring the model accuracy, thereby significantly reducing the costs of training.

The embodiments of the present disclosure provide an action recognition method, which include:
augmenting an original video to obtain a plurality of augmented video segments;
extracting multi-level video features of the plurality of augmented video segments based on a pre-trained action recognition model, and outputting an action recognition result of the original video according to the multi-level video features of the plurality of augmented video segments.

The embodiments of the present disclosure also provide an action recognition apparatus, which include an augmentation module and a recognition module.

The augmentation module is configured to augment an original video to obtain a plurality of augmented video segments.

The recognition module is configured to extract multi-level video features of the plurality of augmented video segments based on a pre-trained action recognition model, and output an action recognition result of the original video according to the multi-level video features of the plurality of augmented video segments.

The embodiments of the present disclosure also provide an electronic device, which includes:
one or more processors, and
a storage apparatus which is configured to store one or more one programs.

When the one or more programs is executed by the one or more processors, the one or more processors perform the action recognition method according to any embodiment of the present disclosure.

The embodiments of the present disclosure also provide a storage medium including computer-executable instructions. When executed by a computer processor, the computer-executable instructions are used to perform the action recognition method according to any embodiment of the present disclosure.

### BRIEF DESCRIPTION OF DRAWINGS

FIG. 1 is a flow schematic diagram of an action recognition method provided by Embodiment 1 of the present disclosure;

FIG. 2 is a flow schematic diagram of model training in the action recognition method provided by Embodiment 1 of the present disclosure;

FIG. 3 is a flow block diagram of an action recognition method provided by Embodiment 2 of the present disclosure;

FIG. 4 is a structural schematic diagram of an action recognition apparatus provided by Embodiment 4 of the present disclosure; and

FIG. 5 is a structural schematic diagram of an electronic device provided by Embodiment 4 of the present disclosure.

### DETAILED DESCRIPTION

The embodiments of the present disclosure are described below with reference to the accompanying drawings. Although some of the embodiments of the present disclosure are illustrated in the accompanying drawings, the present disclosure may be embodied in various forms and should not be construed as limited to the embodiments set forth herein. Rather, these embodiments are provided for understanding the present disclosure. The accompanying drawings and embodiments of the present disclosure are only used for illustration, and are not used to limit the protection scope of the present disclosure.

A plurality of steps recited in the method implementation of the present disclosure may be performed in a different order and/or in parallel. Furthermore, the method implementation may include additional steps and/or omit execution of illustrated steps. The scope of the present disclosure is not limited in this respect.

As used herein, the term “including” and its variants are open-ended including, that is, “including but not limited to”. The term “based on” is “at least partially based on”. The term “one embodiment” represents “at least one embodiment”; the term “another embodiment” represents “at least one other embodiment”; and the term “some embodiments” represents “at least some embodiments”. Related definitions of other terms will be given in the following description.

The concepts such as “first”, “second” and the like mentioned in the present disclosure are only used to distinguish between different devices, modules or units, and are not used to limit the order or interdependence of functionalities performed by such devices, modules or units.

The modifications such as “a”, “a plurality of” and the like mentioned in the present disclosure are schematic rather than limiting, and should be understood as “one or more” unless otherwise indicated by the context.

### Embodiment 1

FIG. 1 is a flow schematic diagram of an action recognition method provided by Embodiment 1 of the present disclosure. The embodiment of the present disclosure is applicable to a situation where action recognition is performed on a video, for example, to a situation where action recognition is performed on a video based on an action recognition model obtained by means of training on a small amount of data. The method may be performed by the action recognition apparatus, which can be implemented in the form of software and/or hardware, can be configured in an electronic device, such as in a computer.

As illustrated in FIG. 1, the action recognition method provided by this embodiment may include the following steps.

S110: augmenting an original video to obtain a plurality of augmented video segments.

The action recognition of the video may include identifying an action category of an action performed by an object in the video. For example, the action category such as “running, jumping, throwing, or waving” by a man in the video is identified. In the action recognition, the approaches of inputting of different video frames from the same video can significantly improve model prediction. In this embodiment, different augmentation approaches can be adopted to obtain a plurality of augmented video segments on the basis of the original video, so as to implement the inputting of different video frames of the original video into the action recognition model. The augmentation of the original video may include processing such as sampling, cropping, rotating, mirroring, and brightness adjusting the video frames of the original video.

In some alternative implementations, the augmenting an original video to obtain a plurality of augmented video segments may include: cropping a plurality of video frames of the original video according to a preset cropping rule, and generating a plurality of augmented video segments augmented in a spatial dimension according to the cropped plurality of video frames; and/or, cutting out a preset number of video clips from the original video, and determining the plurality of video clips respectively as a plurality of augmented video segments augmented in a temporal dimension.

The cropping of the plurality of video frames of the original video according to a preset cropping rule may be conducted by adopting for example Three Crop, Ten Crop or another cropping rule. Exemplarily, in the settings of Three Crop, each of the video frames of the original video may be cropped into three equal-area random regions according to a same cropping approach, and the augmented videos may be generated according to the same cropped regions in the plurality of video frames, so as to obtain three video sub-segments. In the settings of Ten Crop, each of the video frames of the original video may be cropped from the upper left corner, the lower left corner, the upper right corner, the lower right corner, and the center into five equal-area regions, and then flipped horizontally, and the augmented videos may be generated according to the cropped regions in the plurality of video frames and whether they are flipped or not, so as to obtain ten video sub-segments. By cropping, regions characterizing different spatial semantics can be extracted from the video frames, so that the augmentation of the original video in the spatial dimension can be implemented, and a plurality of augmented video segments augmented in the spatial dimension are obtained.

The preset number may be set according to empirical values or experimental values, for example, 10, 24, etc. The number of video frames in each of the cutout video clips may be a fixed numerical value, which may be determined according to a value of number of video frames processed by the action recognition model in a single batch. For example, when the action recognition model can process 8 video frames in a single batch, the number of video frames of the cutout video fragment may be 8. By cutting out the video clips in the original video, the augmentation of the original video in the temporal dimension can be implemented, and a plurality of augmented video segments augmented in a temporal dimension are obtained.

In such alternative implementations, the original video can be augmented in the spatial dimension and/or temporal dimension as described above to obtain a plurality of augmented video segments, which is beneficial for the action recognition model to mine the features of the action categories in the original video from different perspectives according to such augmented videos, and can improve the accuracy for action recognition.

S120: extracting multi-level video features of the plurality of augmented video segments based on a pre-trained action recognition model, and outputting an action recognition result of the original video according to the multi-level video features of the plurality of augmented video segments.

Action recognition may include identifying spatial semantic and identifying action rhythm. The spatial semantic may describe information such as outline, shape, and the like of action. The action rhythm may characterize dynamics and time scale of action, which for example, can be categorized as fast-paced, slow-paced, etc. Some action categories have similar spatial semantics but different action rhythms. For example, the action category of “walking” and the action category of “running” have similar spatial semantics, but “walking” may be of slow-paced whereas “running” may be of fast-paced. Therefore, the recognition of action rhythm is crucial in action recognition.

In this embodiment, the action recognition model can extract multi-level video features from low to high from each of the augmented video segments by means of a series of temporal convolutions. Thus, in a single model, the capturing of fast-paced information and slow-paced information through video features with different depths can be realized, which is helpful for fine-grained differentiation of action categories. In addition, the feeding of input frames to the action recognition model at a single rate can be realized, without categorizing the videos according to the action rhythm before entering them the model, which can simplify the recognition operation and improve the recognition efficiency.

The outputting an action recognition result of the original video according to the multi-level video features of the plurality of augmented video segments may include: fusing, for the plurality of augmented video segments, the multi-level video features characterizing different action rhythms, so as to output action category labels for the original video (e.g., which can be expressed in numerical value); determining the action category of the original video according to a plurality of action category labels, for example, weighting and summing the numerical values of the plurality of action category labels to determine a final category label, and taking the action category corresponding to the final category label as the action category of the original video, i.e., obtaining the action recognition result of the original video.

In some alternative implementations, when the augmented video includes the plurality of augmented video segments augmented in a spatial dimension and the plurality of augmented video segments augmented in a temporal dimension, the outputting an action recognition result of the original video according to the multi-level video features of the plurality of augmented video segments may include: outputting the action recognition result of the original video according to the multi-level video features of the plurality of augmented video segments augmented in the spatial dimension and the multi-level video features of the plurality of augmented video segments augmented in the temporal dimension.

In such alternative implementations, the action category labels may be determined based on the multi-level video features of the plurality of augmented video segments augmented in the spatial dimension and the multi-level video features of the plurality of augmented video segments augmented in the temporal dimension, respectively. Moreover, both kinds of category labels may be weighted and summed to determine the action category of the original video. By integrating the augmented videos in the spatial dimension and the augmented videos in the temporal dimension for prediction, it is beneficial to predict the action category based on the temporal and spatial consistency, which may improve the recognition accuracy.

In the embodiment of the present disclosure, by coding the video features with different depths to capture the fast-paced and slow-paced information in the video, and aggregating the information at multiple rhythms on the feature layer, the accuracy for action recognition can be improved. By aggregating the multi-level video features of the plurality of augmented video segments by the action recognition model for action recognition, the consistency for action recognition can be guaranteed and the accuracy for action recognition can be improved.

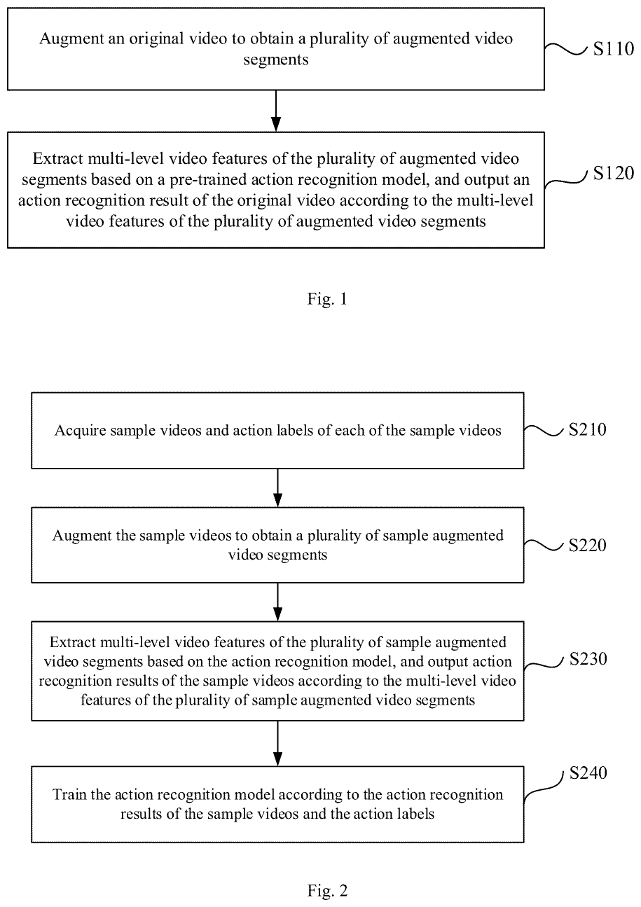

Exemplarily, FIG. 2 is a flow schematic diagram of model training in the action recognition method provided by Embodiment 1 of the present disclosure. Referring to FIG. 2, in some implementations, the action recognition model may be trained based on the following steps.

S210: acquiring sample videos and action labels of each of the sample videos.

The sample videos may be video data for multiple kinds of action categories acquired from an open source library, and/or may also be video data of the collected objects under the multiple kinds of action categories, with the collected objects' authorization. The action categories of the actions performed by the objects in the video data may be labelled by means of manual labelling.

S220: augmenting the sample videos to obtain a plurality of sample augmented video segments.

The augmentation process of the sample videos during the training may be consistent with the augmentation process of the original video during the actual application. For example, the sample videos may be augmented in spatial dimension and/or temporal dimension as described above to obtain the plurality of sample augmented videos.

S230: extracting multi-level video features of the plurality of sample augmented video segments based on the action recognition model, and outputting action recognition results of the sample videos according to the multi-level video features of the plurality of sample augmented video segments.

The process of extracting the multi-level video features of the plurality of sample augmented video segments during the training may be consistent with the process of extracting the multi-level video features of the plurality of augmented video segments during the actual application. For example, the multi-level video features of the plurality of sample augmented video segments may be extracted by means of a series of temporal convolutions. Moreover, for the plurality of sample augmented video segments, the multi-level video features characterizing different action rhythms may also be fused to output the action category labels of the sample videos; and the action categories of the sample videos may be determined according to the plurality of action category labels.

S240: training the action recognition model according to the action recognition results of the sample videos and the action labels.

After outputting the action categories of the sample videos, deviation values between the output action categories and the action labels may be calculated. Moreover, a plurality of parameters in the action recognition model may be trained with the calculated deviation values being less than a preset value as the goal, so that the action recognition model can learn a logical relationship between the multi-level video features and the action categories.

In the training of the action recognition model, due to the ambiguity and instability of video and the diversity of action categories, each kind of action requires sufficient volume of video data to model the video features. To acquire such a large amount of training data, it requires a lot of manual screening and sample labelling. However, in the method of training the action recognition model disclosed by this embodiment, different action rhythms can be captured by extracting sample video features with different depths for coding, which is helpful to capture multi-grained and task-oriented clues in a data-efficient environment, so as to improve the recognition accuracy with few samples; and by augmenting the samples and integrating the video features of a plurality of augmented samples for prediction, it is beneficial for recognition with fewer samples, and the consistency and accuracy for action recognition can be guaranteed. To sum up, the model training is completed based on a small amount of data while ensuring the model accuracy, thereby significantly reducing the costs of training.

The technical solution of the embodiments of the disclosure augments an original video to obtain a plurality of augmented video segments; extracts multi-level video features of the plurality of augmented video segments based on a pre-trained action recognition model, and outputs an action recognition result of the original video according to the multi-level video features of the plurality of augmented video segments. By extracting different levels of video features by the action recognition model, information characterizing different action rhythms can be obtained, and the accuracy for action recognition can be improved. By aggregating the multi-level video features of the plurality of augmented video segments by the action recognition model for action recognition, the consistency for action recognition can guaranteed and the accuracy for action recognition can be improved.

Since the action recognition model can extract and collect the multi-level video features of the plurality of augmented video segments for action recognition, it can be realized that during the training: different action rhythms can be captured by extracting sample video features with different depths for coding, which is helpful to capture multi-grained and task-oriented clues in a data-efficient environment, so as to improve the recognition accuracy with few samples; and by augmenting the samples and integrating the video features of a plurality of augmented samples for prediction, it is beneficial for recognition with few samples, and the consistency and accuracy for action recognition can be guaranteed. To sum up, the training of the model can be achieved based on a small amount of data on the basis of guaranteeing the accuracy of the model, which greatly reduces the training cost.

### Embodiment 2

The embodiment of the present disclosure may be combined with a plurality of alternatives in the action recognition method provided by the above embodiment. The action recognition method provided by this embodiment describes the step of extracting the multi-level video features of the plurality of augmented video segments and the step of performing action recognition based on the multi-level video features of the plurality of augmented video segments. By processing the features of video frames at a lower frame rate and a slower refresh rate, it is helpful to capture the semantic information provided by a small amount of sparse frames. By performing subsequent spatial modulation and/or temporal modulation on the multi-level video features, supplementary annotations for multi-grained motion clues can be captured. By fusing the output results of multiple models, the consistency for action recognition can be guaranteed, and the robustness and accuracy for recognition can be improved.

In some alternative implementations, the extracting multi-level video features of the plurality of augmented video segments based on a pre-trained action recognition model includes: sampling, based on the pre-trained action recognition model, each of the augmented video segments at a preset frame rate interval, and extracting the multi-level video features of the sampled plurality of video frames.

The preset frame rate interval may be preset with sampling at a low frame rate as the goal, for example, may be set to sample video clips of 30 frames per second at a frame rate interval of two frames per second. After sampling the augmented videos at the preset frame rate interval, the multi-level video features of the plurality of video frames may be extracted based on a feature extraction network for residual class, so as to capture the fast-paced information and slow-paced information.

Exemplarily, a complete Slow-Fast network may be adopted to realize the sampling of the augmented videos and the extracting of the sampled multi-level video features of the plurality of video frames. The Slow-Fast network may include a Slow Path (Slow Branch) for processing samples with low frame rate and a Fast Path (Fast Branch) for processing samples with high frame rate, so that multi-grained action rhythm information can be extracted. It is found by researches that the Fast Branch brings less performance improvement for action recognition, but will obviously slow down the training of the model. Therefore, by truncating the Fast branch to simplify the network and forming a network including only the Slow Branch (which can be referred to as Slow-Only network), the extraction of the multi-level video features at a lower frame rate and a slower refresh rate can be achieved.

In such alternative implementations, a small amount of sparse frames can be captured by sampling the augmented videos at a lower frame rate and a slower refresh rate, so that it is helpful to extract richer semantic feature information and the accuracy for action recognition can be improved.

In some alternative implementations, the method further includes, after the extracting multi-level video features of the plurality of augmented video segments based on a pre-trained action recognition model, performing, on the multi-level video features of the plurality of augmented video segments, spatial modulation and/or temporal modulation; accordingly, the outputting an action recognition result of the original video according to the multi-level video features of the plurality of augmented video segments includes: outputting the action recognition result of the original video according to the modulated multi-level video features of the plurality of augmented video segments.

The spatial modulation of the multi-level video features may include: processing different levels of video features into equal-sized feature images by means of convolution and the like, achieving the alignment of spatial semantics. The temporal modulation of the multi-level video features may include: sampling different levels of features on channels according to a set of different sampling rate parameters to reduce sampling features. The feature information of different action rhythms may be aligned and obtained through the spatial modulation layer and the temporal modulation layer. After the spatial modulation and/or temporal modulation are performed on the multi-level video features, action recognition task-oriented supplementary information with more granularities can be provided, so that it is beneficial to improve the accuracy for action recognition.

Exemplarily, the action recognition model may adopt a network structure of Temporal Pyramid Network (TPN). The TPN may be a plug-and-play network, and may include a backbone coding layer, a spatial modulation layer, a temporal modulation layer, an information stream layer and a prediction layer. The backbone coding network may be an ordinary residual network, or the above Slow-Only network, which may be used to extract different levels of video features. The feature information of different action rhythms can be aligned and obtained through the spatial modulation layer and the temporal modulation layer. Different levels of video features can be fused through the information stream layer, so as to aggregate the information of different action rhythms on the feature layer. Different levels of video features can be pooled through the prediction layer, and different levels of video features can be concatenated in channel dimension for predicting the action category.

In such alternative implementations, by performing subsequent spatial modulation and/or temporal modulation on the multi-level video features, supplementary annotations for multi-granularity motion clues can be captured. In addition, during the training of the action recognition model, the spatial modulation and/or temporal modulation may also be performed on the multi-level video features of the plurality of sample augmented video segments, and the action recognition result may be output based on the modulated multi-level video features, which may be beneficial to capture multi-grained, multi-level and task-oriented supplementary information from a small amount of samples during the training.

In some alternative implementations, the action recognition model includes at least one action recognition model. Accordingly, the outputting an action recognition result of the original video according to the multi-level video features of the plurality of augmented video segments includes: determining an initial action recognition result output by the at least one action recognition model according to the multi-level video features of the plurality of augmented video segments; and fusing a plurality of initial action recognition results to obtain the action recognition result of the original video.

Different action recognition models may differ the way of extracting the multi-level video features, the way of determining the action recognition result, or the depth of network layers. By performing action recognition on the original video based on different action recognition models, the robustness for recognition results can be improved.

Each of the augmented video segments may be input into at least one action recognition model for action recognition, or may be input into some of action recognition models for action recognition. Moreover, when each of the augmented video segments is input into at least one action recognition model for action recognition, an initial action recognition result output by the at least one action recognition model according to the multi-level video features of each of the segments of augmented vides can be obtained. When there is an augmented video which is input into some of action recognition models, an initial action recognition result output by each of the action recognition models for the input augmented video may be recorded. The initial action recognition result may be an initial action category label (e.g., which can be represented by a numerical value).

Fusing a plurality of initial action recognition results to obtain the action recognition result of the original video may include, for example: weighting and summing the numerical values of a plurality of initial action category labels to determine the final category label, and taking the action category corresponding to the final category label as the action category of the original video, i.e., obtaining the action recognition result of the original video.

Exemplarily, the initial action recognition results can be fused by the following formula for predicting the action recognition result of the original video:

$$pred = \frac{{\sum }_{i = 1}^{{N}_{a}} {\sum }_{j = 1}^{{M}_{a}} s ( {a}_{i , j} ) + {\sum }_{p = 1}^{{N}_{b}} {\sum }_{q = 1}^{{M}_{b}} s ( {b}_{p , q} )}{{M}_{a} \times {N}_{a} + {M}_{b} \times {N}_{b}} ; \qquad ( Formula 1 )$$

where pred can represent the final action recognition result of the original video, and can be output in the form of a label;
where i is an identification of Class A action recognition models with different network layer depths, Nₐ represents the total number of Class A action recognition models; j is an identification of different augmented videos input into Class A action recognition models, Mₐ represents the total number of augmented videos input into Class A action recognition models; and s(a_{i,j}) represents the initial action recognition result of the j-th augmented video output by the i-th Class A action recognition model;
where p is an identification of Class B action recognition models with different network layer depths, N_{b} represents the total number of Class B action recognition models; q is an identification of different augmented videos input into Class B action recognition models, M_{b} represents the total number of augmented videos input into Class B action recognition models; and s(b_{p,q}) represents the initial action recognition result of the q-th augmented video output by the p-th Class B action recognition model.

The action recognition result of the original video may be obtained by averaging the plurality of initial action recognition results.

In such alternative implementations, by fusing the output results of multiple models, the consistency for action recognition can be guaranteed, and the robustness and the recognition accuracy can be improved.

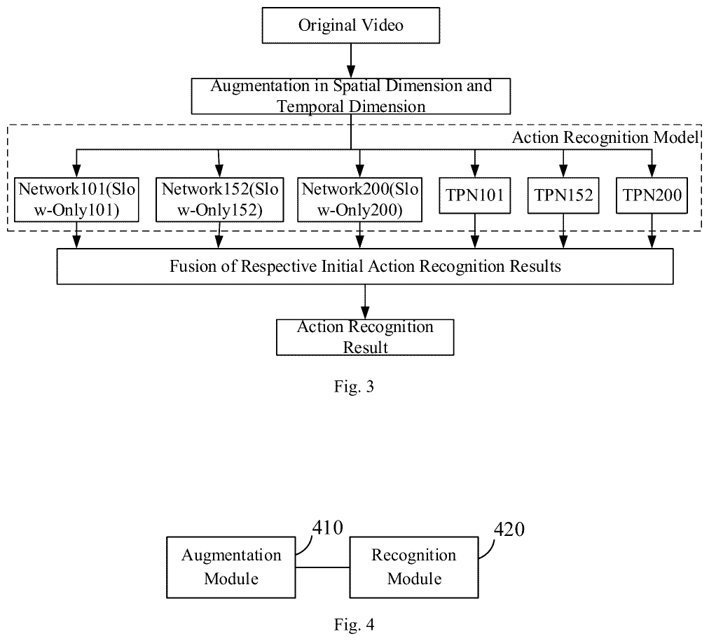

Exemplarily, FIG. 3 is a flow block diagram of an action recognition method provided by Embodiment 2 of the present disclosure. As illustrated in FIG. 3, the action recognition method provided by this embodiment may include the following steps.

An original video is augmented in the spatial dimension and the temporal dimension to obtain a plurality of augmented video segments.

The plurality of augmented video segments may be selectively input into six action recognition models, so as to output initial action recognition results respectively. The action recognition models may include two categories: one category may be models with different network depths that extract multi-level video features through Slow-Only (e.g., Slow-Only101, Slow-Only152, and Slow-Only200); and the other category may be models with different network depths that perform the spatial and temporal modulation on extracted multi-level video features through TPN (e.g., TPN101, TPN152 and TPN200). The numerical value of the suffix of each model may represent the network depth, for example, the suffix “101” of the Slow-Only 101 model may represent that the network depth of the model is 101 layers.

The plurality of initial action recognition results may be fused. For example, it is possible, with reference to the above (Formula 1), to weight and sum the initial action recognition results of the augmented videos input into the action recognition model 1-3 and the initial action recognition results of the augmented videos input into the action recognition model 4-6, respectively, so as to determine the final category label.

The action recognition result may be output. The action recognition result of the original video is obtained by taking the action category corresponding to the final category label as the action category of the original video. The action category corresponding to the fused numerical value may be taken as the action category of the original video.

The technical solution of the embodiment of the present disclosure describes the step of extracting the multi-level video features of the plurality of augmented video segments and the step of performing action recognition based on the multi-level video features of the plurality of augmented video segments. By processing the features of video frames at a lower frame rate and a slower refresh rate, it is helpful to capture the semantic information provided by a small amount of sparse frames. By performing subsequent spatial modulation and/or temporal modulation on the multi-level video features, supplementary annotations for multi-granularity motion clues can be captured. By fusing the output results of multiple models, the consistency for action recognition can be guaranteed, and the robustness and accuracy for recognition can be improved.

In addition, the action recognition method provided by the embodiment of the present disclosure belongs to the same disclosed concept as the action recognition method provided by the above embodiments, and the technical details not described in detail in this embodiment can be found in the above embodiments. The same technical features in this embodiment have the same effect as that in the above embodiments.

### Embodiment 3

FIG. 4 is a structural schematic diagram of an action recognition apparatus provided by Embodiment 4 of the present disclosure. The action recognition apparatus provided by this embodiment is suitable for a situation where action recognition is performed on video, for example, for a situation where action recognition is performed on a video based on an action recognition model obtained by means of training on a small amount of data.

As illustrated in FIG. 4, the action recognition apparatus provided by this embodiment may include an augmentation module 410 and a recognition module 420.

The augmentation module 410 is configured to augment an original video to obtain a plurality of augmented video segments.

The recognition module 420 is configured to extract multi-level video features of the plurality of augmented video segments based on a pre-trained action recognition model, and output an action recognition result of the original video according to the multi-level video features of the plurality of augmented video segments.

In some alternative implementations, the augmentation module 410 may be configured to:
crop a plurality of video frames of the original video according to a preset cropping rule, and generate a plurality of augmented video segments augmented in a spatial dimension according to the cropped plurality of video frames; and/or,
cut out a preset number of video clips from the original video, and determine the plurality of video clips as a plurality of augmented video segments augmented in a temporal dimension.

In some alternative implementations, when the augmented video includes the plurality of augmented video segments augmented in the spatial dimension and the plurality of augmented video segments augmented in the temporal dimension, the recognition module 420 may be configured to:
output the action recognition result of the original video according to the multi-level video features of the plurality of augmented video segments augmented in the spatial dimension and the multi-level video features of the plurality of augmented video segments augmented in the temporal dimension.

In some alternative implementations, the recognition module 420 may be configured to:
sample, based on the pre-trained action recognition model, each of the augmented video segments at a preset frame rate interval, and extract the multi-level video features of the sampled plurality of video frames.

In some alternative implementations, the recognition module 420 may be further configured to:
after extracting multi-level video features of the plurality of augmented video segments based on a pre-trained action recognition model, perform spatial modulation and/or temporal modulation on the multi-level video features of the plurality of augmented video segments.

The recognition module 420 may be configured to:
output the action recognition result of the original video according to the modulated multi-level video features of the plurality of augmented video segments.

In some alternative implementations, the action recognition model includes at least one action recognition model; accordingly, the recognition module 420 may be configured to:
determine an initial action recognition result output by the at least one action recognition model according to the multi-level video features of the plurality of augmented video segments; and
fuse a plurality of initial action recognition results to obtain the action recognition result of the original video.

In some alternative implementations, the action recognition apparatus may further include a model training module.

The model training module is configured to train the action recognition model based on the following steps:
acquiring sample videos and action labels of each of the sample videos;
augmenting the sample videos to obtain a plurality of sample augmented video segments;
extracting multi-level video features of the plurality of sample augmented video segments based on the action recognition model, and outputting action recognition results of the sample videos according to the multi-level video features of the plurality of sample augmented video segments; and
training the action recognition model according to the action recognition results of the sample videos and the action labels.

The action recognition apparatus provided by the embodiments of the present disclosure can perform the action recognition method provided by any of the embodiments of the present disclosure, and has corresponding functional modules and effects.

The plurality of units and modules included in the device are only divided according to functional logic, but are not limited to the above division, as long as corresponding functions can be realized. Additionally, the names of the plurality of functional units are only for the convenience of distinguishing from each other, and are not used to limit the protection scope of the embodiments of the present disclosure.

### Embodiment 4

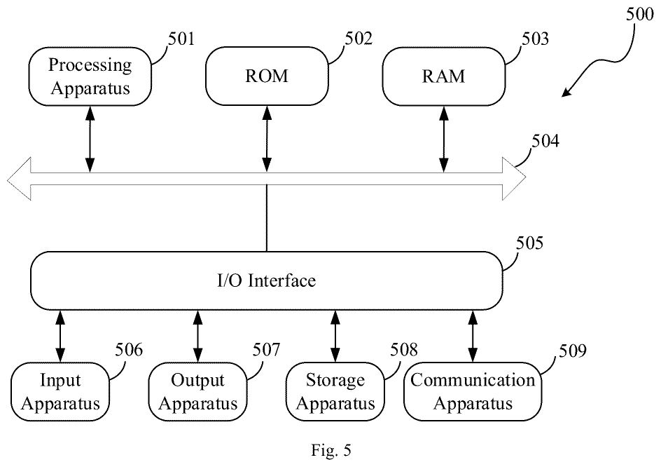

Referring to FIG. 5, FIG. 5 illustrates a schematic structural diagram of an electronic device 500 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

The following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The electronic device provided by the embodiment of the present disclosure belongs to the same inventive concept as the action recognition method provided by the above embodiments, and the technical details which are not described in detail in this embodiment can be found in the above embodiments, and this embodiment has the same effects as the above embodiments.

### Embodiment 5

The embodiment of the present disclosure provides a computer storage medium on which a computer program is stored. When the computer program is executed by a processor, the action recognition method provided in the above embodiments is performed.

The above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. Examples of the computer-readable storage medium may include but not be limited to: an electrical connection with one or more wires, a portable computer disk, a hard disk, a RAM, a ROM, an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
augment an original video to obtain a plurality of augmented video segments; extract multi-level video features of the plurality of augmented video segments based on a pre-trained action recognition model, and output an action recognition result of the original video according to the multi-level video features of the plurality of augmented video segments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including the LAN or WAN, or the connection may be made to an external computer (for example, through the Internet using an Internet service provider).

The flowcharts and block diagrams in the accompanying drawings illustrate the architecture, functionality, and operation of possible implementations of systems, methods, and computer program products according to multiple embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. The name of the module or unit does not constitute a limitation of the unit itself under a circumstance.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, RAM, ROM, EPROM or flash memory, optical fiber, CD-ROM, optical storage device, magnetic storage device, or any suitable combination of the foregoing. The storage medium may be a non-transitory storage medium.

According to one or more embodiments, [Example 1] provides an action recognition method, which includes:
augmenting an original video to obtain a plurality of augmented video segments;
extracting multi-level video features of the plurality of augmented video segments based on a pre-trained action recognition model, and outputting an action recognition result of the original video according to the multi-level video features of the plurality of augmented video segments.

According to one or more embodiments, [Example 2] provides an action recognition method, in the method:
in some alternative implementations, the augmenting an original video to obtain a plurality of augmented video segments includes:
cropping a plurality of video frames of the original video according to a preset cropping rule, and generating a plurality of augmented video segments augmented in a spatial dimension according to the cropped plurality of video frames; and/or,
cutting out a preset number of video clips from the original video, and determining the plurality of video clips as a plurality of augmented video segments augmented in a temporal dimension respectively.

According to one or more embodiments, [Example 3] provides an action recognition method, in the method:
in some alternative implementations, when the plurality of augmented video segments include the plurality of augmented video segments augmented in the spatial dimension and the plurality of augmented video segments augmented in the temporal dimension, the outputting an action recognition result of the original video according to the multi-level video features of the plurality of augmented video segments includes:
outputting the action recognition result of the original video according to multi-level video features of the plurality of augmented video segments augmented in the spatial dimension and multi-level video features of the plurality of augmented video segments augmented in the temporal dimension.

According to one or more embodiments, [Example 4] provides an action recognition method, in the method:
in some alternative implementations, the extracting multi-level video features of the plurality of augmented video segments based on a pre-trained action recognition model includes:
sampling, based on the pre-trained action recognition model, each augmented video segment at a preset frame rate interval, and extracting the multi-level video features of the sampled plurality of video frames.

According to one or more embodiments, [Example 5] provides an action recognition method, in the method:
in some alternative implementations, after the extracting multi-level video features of the plurality of augmented video segments based on a pre-trained action recognition model, the method further comprises:
performing, on the multi-level video features of the plurality of augmented video segments, spatial modulation and/or temporal modulation;
accordingly, the outputting an action recognition result of the original video according to the multi-level video features of the plurality of augmented video segments comprises:
outputting the action recognition result of the original video according to the modulated multi-level video features of the plurality of augmented video segments.
According to one or more embodiments, [Example 6] provides an action recognition method, in the method:
in some alternative implementations, the action recognition model comprises at least one action recognition model, and accordingly, the outputting an action recognition result of the original video according to the multi-level video features of the plurality of augmented video segments comprises:
determining an initial action recognition result output by the at least one action recognition model according to the multi-level video features of the plurality of augmented video segments; and
fusing a plurality of initial action recognition results to obtain the action recognition result of the original video.

According to one or more embodiments, [Example 7] provides an action recognition method, in the method:
in some alternative implementations, the action recognition model is trained based on the following operations:
acquiring sample videos and action labels of each of the sample videos;
augmenting the sample videos to obtain a plurality of sample augmented video segments;
extracting multi-level video features of the plurality of sample augmented video segments based on the action recognition model, and outputting action recognition results of the sample videos according to the multi-level video features of the plurality of sample augmented video segments; and
training the action recognition model according to the action recognition results of the sample videos and the action labels.

According to one or more embodiments, [Example8] provides an action recognition apparatus, which includes an augmentation module and a recognition module.

The augmentation module is configured to augment an original video to obtain a plurality of augmented video segments.

The recognition module is configured to extract multi-level video features of the plurality of augmented video segments based on a pre-trained action recognition model, and output an action recognition result of the original video according to the multi-level video features of the plurality of augmented video segments.

The disclosure scope involved in the present disclosure is not limited to the embodiments formed by the specific combination of the above-mentioned technical features, but also other embodiments formed by any combination of the above-mentioned technical features or their equivalent features without departing from the above-mentioned disclosure concepts. For example, the above features are replaced with technical features having similar functions disclosed in the present disclosure, so as to form an embodiment.

Furthermore, although the various operations are depicted in a particular order, it should not be understood as requiring that these operations be performed in the particular order as illustrated or in a sequential order. Under a certain circumstance, multitasking and parallel processing may be beneficial. Likewise, although multiple implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are only exemplary forms of implementing the claims.

1. An action recognition method, comprising:
augmenting an original video to obtain a plurality of augmented video segments;
extracting multi-level video features of the plurality of augmented video segments based on a pre-trained action recognition model, and outputting an action recognition result of the original video according to the multi-level video features of the plurality of augmented video segments.

2. The method according to claim 1, wherein the augmenting an original video to obtain a plurality of augmented video segments comprises at least one of:
cropping a plurality of video frames of the original video according to a preset cropping rule, and generating a plurality of augmented video segments augmented in a spatial dimension according to the cropped plurality of video frames; or,
cutting out a preset number of video clips from the original video, and determining the plurality of video clips as a plurality of augmented video segments augmented in a temporal dimension respectively.

3. The method according to claim 2, wherein when the plurality of augmented video segments comprise the plurality of augmented video segments augmented in the spatial dimension and the plurality of augmented video segments augmented in the temporal dimension, the outputting an action recognition result of the original video according to the multi-level video features of the plurality of augmented video segments comprises:
outputting the action recognition result of the original video according to multi-level video features of the plurality of augmented video segments augmented in the spatial dimension and multi-level video features of the plurality of augmented video segments augmented in the temporal dimension.

4. The method according to claim 1, wherein the extracting multi-level video features of the plurality of augmented video segments based on a pre-trained action recognition model comprises:
sampling, based on the pre-trained action recognition model, each augmented video segment at a preset frame rate interval, and extracting the multi-level video features of the sampled plurality of video frames.

5. The method according to claim 1, after the extracting multi-level video features of the plurality of augmented video segments based on a pre-trained action recognition model, further comprising:
performing, on the multi-level video features of the plurality of augmented video segments, at least one of: spatial modulation or temporal modulation;
the outputting an action recognition result of the original video according to the multi-level video features of the plurality of augmented video segments comprises:
outputting the action recognition result of the original video according to the modulated multi-level video features of the plurality of augmented video segments.

6. The method according to claim 1, wherein the action recognition model comprises at least one action recognition model, and the outputting an action recognition result of the original video according to the multi-level video features of the plurality of augmented video segments comprises:
determining an initial action recognition result output by the at least one action recognition model according to the multi-level video features of the plurality of augmented video segments; and
fusing a plurality of initial action recognition results to obtain the action recognition result of the original video.

7. The method according to claim 1, wherein the action recognition model is trained based on the following operations:
acquiring sample videos and action labels of each of the sample videos;
augmenting the sample videos to obtain a plurality of sample augmented video segments;
extracting multi-level video features of the plurality of sample augmented video segments based on the action recognition model, and outputting action recognition results of the sample videos according to the multi-level video features of the plurality of sample augmented video segments; and
training the action recognition model according to the action recognition results of the sample videos and the action labels.

8. (canceled)

9. An electronic device, comprising:
at least one processor; and
a storage apparatus, configured to store at least one program,
wherein the at least one program, when executed by the at least one processor, causes the at least one processor to;
augment an original video to obtain a plurality of augmented video segments;
extract multi-level video features of the plurality of augmented video segments based on a pre-trained action recognition model, and output an action recognition result of the original video according to the multi-level video features of the plurality of augmented video segments.

10. A non-transitory storage medium comprising computer-executable instructions, wherein the computer-executable instructions, when executed by a computer processor, cause the computer processor to:
augment an original video to obtain a plurality of augmented video segments;
extract multi-level video features of the plurality of augmented video segments based on a pre-trained action recognition model, and output an action recognition result of the original video according to the multi-level video features of the plurality of augmented video segments.

11. The electronic device according to claim 9, wherein the at least one processor is further configured to:
crop a plurality of video frames of the original video according to a preset cropping rule, and generate a plurality of augmented video segments augmented in a spatial dimension according to the cropped plurality of video frames; and/or,
cut out a preset number of video clips from the original video, and determine the plurality of video clips as a plurality of augmented video segments augmented in a temporal dimension respectively.

12. The electronic device according to claim 11, wherein when the plurality of augmented video segments comprise the plurality of augmented video segments augmented in the spatial dimension and the plurality of augmented video segments augmented in the temporal dimension, the at least one processor is further configured to:
output the action recognition result of the original video according to multi-level video features of the plurality of augmented video segments augmented in the spatial dimension and multi-level video features of the plurality of augmented video segments augmented in the temporal dimension.

13. The electronic device according to claim 9, wherein the at least one processor is further configured to:
sample, based on the pre-trained action recognition model, each augmented video segment at a preset frame rate interval, and extract the multi-level video features of the sampled plurality of video frames.

14. The electronic device according to claim 9, wherein after extracting multi-level video features of the plurality of augmented video segments based on a pre-trained action recognition model, the at least one processor is further configured to:
perform, on the multi-level video features of the plurality of augmented video segments, at least one of: spatial modulation or temporal modulation;
output the action recognition result of the original video according to the modulated multi-level video features of the plurality of augmented video segments.

15. The electronic device according to claim 9, wherein the action recognition model comprises at least one action recognition model, and the at least one processor is further configured to:
determine an initial action recognition result output by the at least one action recognition model according to the multi-level video features of the plurality of augmented video segments; and
fuse a plurality of initial action recognition results to obtain the action recognition result of the original video.

16. The electronic device according to claim 9, wherein the action recognition model is trained based on the following operations:
acquiring sample videos and action labels of each of the sample videos;
augmenting the sample videos to obtain a plurality of sample augmented video segments;
extracting multi-level video features of the plurality of sample augmented video segments based on the action recognition model, and outputting action recognition results of the sample videos according to the multi-level video features of the plurality of sample augmented video segments; and
training the action recognition model according to the action recognition results of the sample videos and the action labels.

17. The non-transitory storage medium according to claim 10, wherein the computer-executable instructions are further used to:
crop a plurality of video frames of the original video according to a preset cropping rule, and generate a plurality of augmented video segments augmented in a spatial dimension according to the cropped plurality of video frames; and/or,
cut out a preset number of video clips from the original video, and determine the plurality of video clips as a plurality of augmented video segments augmented in a temporal dimension respectively.

18. The non-transitory storage medium according to claim 17, wherein when the plurality of augmented video segments comprise the plurality of augmented video segments augmented in the spatial dimension and the plurality of augmented video segments augmented in the temporal dimension, the computer-executable instructions are further used to:
output the action recognition result of the original video according to multi-level video features of the plurality of augmented video segments augmented in the spatial dimension and multi-level video features of the plurality of augmented video segments augmented in the temporal dimension.

19. The non-transitory storage medium according to claim 10, wherein the computer-executable instructions are further used to:
sample, based on the pre-trained action recognition model, each augmented video segment at a preset frame rate interval, and extract the multi-level video features of the sampled plurality of video frames.

20. The non-transitory storage medium according to claim 10, wherein after extracting multi-level video features of the plurality of augmented video segments based on a pre-trained action recognition model, the computer-executable instructions are further used to:
perform, on the multi-level video features of the plurality of augmented video segments, at least one of: spatial modulation or temporal modulation; and
output the action recognition result of the original video according to the modulated multi-level video features of the plurality of augmented video segments.

21. The non-transitory storage medium according to claim 10, wherein the action recognition model comprises at least one action recognition model, and the computer-executable instructions are further used to:
determine an initial action recognition result output by the at least one action recognition model according to the multi-level video features of the plurality of augmented video segments; and
fuse a plurality of initial action recognition results to obtain the action recognition result of the original video.
